(19) United States
(12) Patent Application Publication
(10) Pub. No.: US 2023/0356171 A1
(43) Pub. Date: Nov. 9, 2023

(54) THERMAL INTEGRATION OF AN ELECTRICALLY HEATED REACTOR

(71) Applicants: BASF SE, Ludwigshafen am Rhein (DE); Linde GmbH, Pullach (DE)

(72) Inventors: Eric JENNE, Ludwigshafen am Rhein (DE); Kiara Aenne KOCHENDOERFER, Ludwigshafen am Rhein (DE); Andrey SHUSTOV, Ludwigshafen am Rhein (DE)

(21) Appl. No.: 18/029,385

(22) PCT Filed: Oct. 1, 2021
(86) PCT No.: PCT/EP2021/077144

§ 371 Date: Mar. 30, 2023

(30) Foreign Application Priority Data
Oct. 2, 2020 (EP) 20199922.4

(51) Int. Cl. B01J 19/00; B01J 19/24; C01B 3/34; C10G 9/36; C10J 1/26

(52) U.S. Cl. CPC B01J 19/0013; B01J 19/2465; C01B 3/346; C10G 9/36; C10J 1/26; B01J 2219/00087; B01J 2219/00135; B01J 2219/00159; B01J 2219/00108; B01J 2219/0011; B01J 2219/00128; C01B 2203/0233; C01B 2203/1241; C01B 2203/1252; C01B 2203/1247; C01B 2203/0894; C01B 2203/085; C01B 2203/0838; C01B 2203/0883; C10G 2400/22; C10G 2400/30

(57) ABSTRACT

The present invention proposes a plant (110) for producing reaction products. The plant (110) comprises at least a preheater (114). The plant (110) comprises at least one raw material supply (118) which is adapted for supplying at least one raw material to the preheater (114). The preheater (114) is adapted for preheating the raw material to a predetermined temperature. The plant (110) comprises at least one electrically heatable reactor (122). The electrically heatable reactor (122) is adapted for at least partially converting the preheated raw material into reaction products and byproducts. The plant (110) comprises at least one heat integration apparatus (132) which is adapted for at least partially supplying the byproducts to the preheater (114). The preheater (114) is adapted for at least partially utilizing energy required for preheating the raw material from the byproducts.

The present invention relates to a plant for producing reaction products and a process for heat integration in a production of reaction products.

Production plants such as steam crackers are known in principle to those skilled in the art, see for example https://de.wikipedia.org/wiki/Steamcracken. In steam crackers naphtha for example is cracked at high temperatures in the presence of steam to afford ethylene and propylene. To this end, in a so-called convection zone of the steam cracker, the naphtha is preheated and hot steam is added. In a subsequent radiant zone the naphtha is cracked into ethylene and propylene at about 850° C. Heating of the steam cracker is conventionally effected by combustion of natural gas which is associated with carbon emission. In conventional steam crackers the heat formed in the natural gas combustion is not only used for cracking but rather the waste heat ascending the chimney is also used for preheating the naphtha in the convection zone. Such conventional production plants are known for example from EP 2 653 524 A1, U.S. Pat. No. 4,361,478 A, EP 0 245 839 A1 or EP3415587A1.

Conventional furnaces are also known from US 2006/116543 A1, DE 10 2018 132736 A1 and US 2011/163003 A1.

Electrically heatable reactors are also known, for example from WO 2015/197181 A1, WO 2020/035575 A1, WO 2020/035574 A1, DE 103 17 197 A1 and WO 2017/186437 A.

Electrically heatable reactors can make it possible to achieve CO2-neutral operation of the reactor.

WO 2015/197181 A1 describes a means for heating a fluid with at least one electrically conductive tube conduit for receiving the fluid and at least one voltage source connected to the at least one tube conduit. The at least one voltage source is configured for producing an electrical alternating current in the at least one tube conduit which heats the at least one tube conduit to heat the fluid.

WO 2020/035575 A1 describes a means for heating a fluid which comprises at least one electrically conductive tube conduit and/or at least one electrically conductive tube conduit segment for accommodating the fluid and at least one direct current and/or direct voltage source. Each tube conduit and/or each tube conduit segment is assigned a respective direct current and/or direct voltage source which is connected to the respective tube conduit and/or to the respective tube conduit segment, wherein the respective direct current and/or direct voltage source is configured to produce an electric current in the respective tube conduit and/or in the respective tube conduit segment which heats the respective tube conduit and/or the respective tube conduit segment through Joule heat formed upon passage of the electric current through conductive tube material to heat the fluid.

WO 2020/035574 A1 describes an apparatus for heating a fluid which comprises at least one electrically conductive tube conduit for accommodating a fluid, and at least one electrically conductive coil and at least one alternating current source which is connected to the coil and adapted for supplying the coil with an alternating voltage. The coil is adapted for producing an electromagnetic field through the supplied alternating voltage. The tube conduit and the coil are arranged such that the electromagnetic field of the coil induces an electric current in the tube conduit which heats the tube conduit through Joule heat formed upon passage of the electric current through conductive tube material to heat the fluid.

An integration of an electrically heatable reactor into the steam cracker is an as yet unsolved challenge. Without heating using natural gas, a convection zone and thus also the possibility of preheating the starting material in particular are omitted. The problem of heat integration of the electrically heated reactor into the plant has not hitherto been solved.

It is accordingly an object of the present invention to provide a plant for producing reaction product and a process for heat integration in a production of reaction products which at least largely avoids the disadvantages of known apparatuses and processes. It is especially an object of the invention to realize heat integration of an electrically heatable reactor in a plant, such as a plant for performing at least one endothermic reaction, a plant for heating, a plant for preheating, a steam cracker, a steam reformer, an apparatus for alkane dehydrogenation, a reformer, an apparatus for dry reforming, an apparatus for styrene production, an apparatus for ethylbenzene dehydrogenation, an apparatus for cracking ureas, isocyanates, melamine, a cracker, a catalytic cracker, an apparatus for dehydrogenation.

This object was achieved by a plant and a process having the features of the independent claims. Preferred embodiments of the invention are specified inter alia in the accompanying subsidiary claims and subsidiary claim dependencies.

Hereinbelow, the terms “have”, “exhibit”, “comprise” or include or any grammatical derivations thereof are used in a nonexclusive manner. Accordingly, these terms may relate to situations in which in addition to the feature introduced by these terms no further features are present or to situations in which one or more further features are present. For example the term “A has B”, “A exhibits B”, “A comprises B” or “A includes B” can relate either to the situation in which, other than B, no further element is present in A (i.e. in a situation in which a consists exclusively of B) or to the situation in which, in addition to B), one or more further elements are present in A, for example element E, elements C and D or even further elements.

It is further noted that the terms “at least one” and “one or more” and also grammatical derivations of these terms or similar terms when these are used in connection with one or more elements or features and are intended to intimate that the element or feature may be provided in singlicate or multiplicate are generally used only once, for example in the first-time introduction of the feature or element. In a subsequent renewed mentioning of the feature or element the corresponding term “at least one” or “one or more” is generally no longer used but this does not limit the possibility that the feature or element is provided in singlicate or multiplicate.

Furthermore, the terms “preferably”, “in particular”, “for example” or similar terms are used hereinbelow in connection with optional features but this does not limit alternative embodiments. Thus, features introduced by these terms are optional features and it is not intended for these features to limit the scope of protection of the claims and in particular of the independent claims. Accordingly, the invention may also be performed using different embodiments, as will be appreciated by those skilled in the art. Similarly, features introduced by the expression “in one embodiment of the invention” or by the expression “in an exemplary embodiment of the invention” are to be understood as optional features without any intention thus to limit alternative embodiments or the scope of protection of the independent claims. Furthermore, these introductory expressions shall leave unaffected all options for combining the features introduced thereby with other features, be they optional features or non-optional pictures.

The first aspect of the present invention proposes a plant for producing reaction products.

In the context of the present invention a “plant” is to be understood as meaning a chemical production plant. By way of example the plant may be selected from the group consisting of: a plant for performing at least one endothermic reaction, a plant for heating, a plant for preheating, a steam cracker, a steam reformer, an apparatus for alkane dehydrogenation, a reformer, an apparatus for dry reforming, and apparatus for styrene production, and apparatus for ethylbenzene dehydrogenation and apparatus for cracking ureas, isocyanates, melamine, a cracker, a catalytic cracker, an apparatus for dehydrogenation. By way of example the plant may be adapted for performing at least one process selected from the group consisting of: at least one endothermic reaction, a preheating, steam cracking, steam reforming, alkane dehydrogenation, a reforming, dry reforming, a styrene production, an ethylbenzene dehydrogenation, cracking of ureas, isocyanates, melamine, a cracking, a catalytic cracking, a dehydrogenation.

The plant comprises at least one preheater. The plant comprises at least one raw material supply which is adapted for supplying at least one raw material to the preheater. The preheater is adapted for preheating the raw material to a predetermined temperature. The plant comprises at least one electrically heatable reactor. The electrically heatable reactor is adapted for at least partially converting the preheated raw material into reaction products and byproducts. The plant comprises at least one heat integration apparatus which is adapted for at least partially supplying the byproducts to the preheater. The preheater is adapted for at least partially utilizing energy required for preheating the raw material from the byproducts.

In the context of the present invention a “preheater” is to be understood as meaning at least one element of the plant which is adapted for preheating the raw material to a predetermined temperature. The raw material may have a first temperature during supply. For example the first temperature maybe 100° C. The preheater may be adapted for heating the raw material to a second temperature, wherein the second temperature is higher than this first temperature. The predetermined temperature may be for example 500° C. to 750° C. The predetermined temperature may depend on the raw material, the intended chemical reaction and/or the reaction products to be produced. The preheater may comprise at least one burner. The preheater may be adapted for producing an energy demand for preheating the raw material by combustion of gases, for example of methane. The gases may also be referred to as heating gases. As is further elucidated below, recycled byproducts may be burnt in the preheater and at least partially provide the energy required for heating in the preheater.

The plant may comprise at least one process steam supply which is adapted for supplying at least one process steam to the preheater. The electrically heatable reactor may be adapted for converting the raw material into a cracked gas in the presence of the process steam. In the context of the present invention a “process steam” is to be understood as meaning steam in whose presence the raw material may be converted into reaction products and byproducts. The process steam may be a hot process steam, for example having a temperature of 180° C. to 200° C. A “process steam supply” may in the context of the present invention be an element of the plant adapted for providing the process steam to the preheater. The process steam supply may comprise at least one tube conduit or a tube conduit system.

In the context of the present invention “raw material” is to be understood as meaning a starting material, also known as a feedstock, from which the reaction products may be generated and/or produced, in particular by at least one chemical reaction. The raw material may in particular be a reactant with which the chemical reaction is to be performed. The raw material may be a liquid or a gaseous raw material. The raw material may comprise at least one element selected from the group consisting of: methane, ethane, propane, butane, naphtha, ethylbenzene, gas oil, condensates, bioliquids, biogases, pyrolysis oils, waste oils and liquids from renewable raw materials. Bioliquids may be for example fats or oils or derivatives thereof from renewable raw materials, for example biooil or biodiesel. In the context of the present invention a “raw material supply” is to be understood as meaning an element which is adapted for providing the raw material to the preheater. The raw material supply may comprise at least one tube conduit or a tube conduit system.

The raw material and the process steam may each be supplied to and through the preheater in tube conduits and be heated thereby. The preheater may in particular be adapted to superheat the raw material. The plant may be adapted for mixing the preheated raw material and the preheated process steam. The raw material mixed with the process steam may, for example via a further conduit, be passed into a zone of the preheater close to the burner and superheated. For example the raw material mixed with the process steam may be superheated to a temperature somewhat below a cracking temperature. The superheated fluid may subsequently be passed into the electrically heatable reactor and cracked therein.

The plant may comprise at least one feed conduit which is adapted for supplying a fluid preheated, in particular superheated, by the preheater to the electrically heatable reactor. In particular, the raw material preheated by the preheater and/or the preheated mixture of raw material and process steam may be supplied to the electrically heatable reactor via the feed conduit. In the context of the present invention a “fluid” is to be understood as meaning a gaseous and/or liquid medium. The fluid may in particular be a mixture of raw material and process steam superheated by the preheater. For example the fluid may be a hydrocarbon for thermal cracking, in particular a mixture of hydrocarbons for thermal cracking. The fluid may for example be water or steam and additionally comprise a hydrocarbon for thermal cracking, in particular a mixture of hydrocarbons for thermal cracking.

The fluid may for example be a preheated mixture of hydrocarbons for thermal cracking and steam.

In the context of the present invention a “reaction product” is to be understood as meaning a main product to be produced, also referred to as a primary product or as a value product. The plant may be adapted for performing at least one chemical reaction in which main products and byproducts are produced. The reaction product may comprise at least one element selected from the group consisting of acetylene, ethylene, propylene, butene, butadiene, benzene, styrene, synthesis gas. In the context of the present invention “byproduct” is to be understood as meaning a further product of the chemical reaction which is generated in addition to the reaction products. The byproduct may comprise for example an element selected from the group consisting of: hydrogen, methane, ethane, propane. In the context of the present invention “at least partially” converting into reaction products and byproducts is to be understood as meaning that embodiments are possible in which the raw material and/or the mixture of raw material and process steam are completely converted and embodiments are possible in which the raw material and/or the mixture of raw material and process steam are incompletely converted.

In the context of the present invention a “reactor”, also known as a chemical reactor, is to be understood as meaning an apparatus which is adapted such that at least one chemical process can proceed therein and/or at least one chemical reaction may be performed therein. In the context of the present invention “electrically heatable” reactor is to be understood as meaning an electrically operated reactor. The electrically heatable reactor may be adapted to heat a fluid present in the reactor using electric current. The electrically heatable reactor may be heatable with electric current. The energy required for the reaction in the electrically heatable reactor may be entirely produced by electric current, in particular in the form of joule heat. It is possible in principle to use electricity from any desired electricity source for heating the reactor. The electricity employed may advantageously be from renewable energy sources, thus further enhancing the climate compatibility of the plant. Furthermore, the use of a preheater for production of the reaction product may mean that only partial energization for processes in the electrically heatable reactor is necessary. The electricity demand can thus be limited. The electrically heatable reactor may employ an electricity and transformer concept that is independent from the remaining elements of the plant.

The electrically heatable reactor differs from conventional furnaces, i.e. furnaces having convection zones, for example known from US 2006/116543 A1, DE 10 2018 132736 A1 and US 2011/163003 A1. The reactions proceeding in the electrically heatable reactor are identical to those in a conventional furnace but the energy for heating and endothermic reaction is produced from electricity, for example by direct or indirect heating. To this end the electrically heatable reactor has an electric current supply, in particular one or more of transformers, conducting electrical connections, switchgear and further electrical equipment. By contrast, conventional furnaces use radiative heat. In particular, in conventional furnaces the energy for heating and endothermic reaction is produced from the combustion of natural gas, methane, Hz. The electrically heatable reactor is thus concerned with ensuring that the reactants, for example preheated naphtha and steam, are reacted to afford a product, wherein the energy required for reaction is produced from electricity. The electrically heatable reactor makes it possible to achieve a CO₂ reduction of up to 100%. The conventional furnace, by contrast, produces CO₂ by combustion of the heating gas. Implementing an electrically heatable reactor with controllers can make it possible to achieve further energy reduction through optimization of reaction or temperature control. An electrically heatable reaction can achieve temperatures higher than those required for the processes but not as high as those achieved by combustion in conventional furnaces. In order to achieve the temperatures electrically heatable reactors may employ large electric currents.

Conventional furnaces do not employ electric current but rather heating gas combustion. A design of the reaction space of the electrically heatable reactor may be influenced by the electrical heating. By contrast, the design of a furnace space of a conventional furnace may be influenced by the gas heating. A material choice for the electrically heatable reactor may be based on process engineering, for example reaction, coke formation, reaction temperature etc., and the electrical heating. In the case of direct heating the ohmic resistance may also be taken into account. In the case of indirect heating a higher degree of freedom in selecting the material may be possible. In conventional furnaces the material choice is based solely on process engineering, for example reaction, coke formation, reaction temperature etc.

Conventional furnaces have a convection zone. The convection zone is defined by the radiant zone and in terms of location the convection zone is necessarily arranged above the radiant zone. A heat integration in conventional furnaces is known to those skilled in the art. In a conventional furnace the heat integration consists for example of the following heat exchangers: boiler feed water preheating, naphtha preheating, process steam superheated, high-pressure steam superheating, input materials superheating. The tubes of these heat exchangers are in a conventional cracking furnace arranged horizontally one above the other in the flue gas stream of the gas burner. In an electrically heatable reactor the convection zone need not necessarily be arranged above the e-furnace radiant zone in terms of location. The arrangement can be more flexible since the heating is carried out via independent gas burners. Since the electrically heatable reactor and the heat integration are decoupled from one another there are degrees of freedom in terms of design and/or location and/or concept.

According to the invention it is proposed to utilize Hz, methane, ethane, and all flammable substances generated from the cracked gas and purified in a separation section, for preheating the raw materials, also known as feed streams, and the steams. The electrically heatable reactor can therefore relate to the reaction downstream of the preheating in which, for example, preheated naphtha and steam are reacted to afford a product. Combustion of the recovered heating gas (Hz, methane, ethane etc.) allows this to be energetically utilized for preheating.

Additional natural gas for preheating may also be obtained from external sources if required. It is possible to effect only partial heat integration.

The electrically heatable reactor may comprise at least one apparatus adapted for accommodating the preheated raw material. The electrically heatable reactor may comprise at least one reaction tube, also referred to as a tube conduit, in which the chemical reaction may proceed. The reaction tube may comprise for example at least one tube conduit and/or at least one tube conduit segment for accommodating the fluid. The terms tube conduit and tube conduit segment are hereinbelow used synonymously. The reaction tube may further be adapted for transporting the fluid preheated by the preheater through the electrically heatable reactor. The geometry and/or surface areas and/or material of the reaction tube may be selected independently of a fluid to be transported. The electrically heatable reactor may comprise a plurality of tube conduits. The electrically heatable reactor may comprise I tube conduits, wherein I is a natural number of not less than two. For example the electrically heatable reactor may comprise at least two, three, four, five or more tube conduits. The electrically heatable reactor may comprise up to one hundred tube conduits for example. The tube conduits may be identical or different.

The tube conduits may comprise symmetrical and/or asymmetrical tubes and/or combinations thereof. In a purely symmetrical embodiment the electrically heatable reactor may comprise tube conduits of an identical tube type. The term “asymmetric tubes” and “combinations of symmetrical and asymmetrical tubes” is to be understood as meaning that the electrically heatable reactor may comprise any desired combination of tube types which may for example be connected in parallel or in series as desired. A “tube type” may be understood as meaning a category or type of tube conduit characterized by certain features. The tube type may be characterized at least by a featured selected from the group consisting of: a horizontal configuration of the tube conduit; a vertical configuration of the tube conduit; a length in the entrance (l1) and/or exit (l2) and/or transition (l3); a diameter in the entrance (d1) and exit (d2) and transition (d3); a number n of passes; length per pass; diameter per pass; geometry, surface area; and material.

The electrically heatable reactor may comprise a combination of at least two different tube types which are connected in parallel and/or in series. For example the electrically heatable reactor may comprise tube conduits of different lengths length in the entrance (l1) and/or exit (l2) and/or transition (l3). For example the electrically heatable reactor may comprise tube conduits having an asymmetry of the diameters in the entrance (d1) and/or exit (d2) and/or transition (d3). For example the electrically heatable reactor may comprise tube conduits having a different number of passes for example. For example the electrically heatable reactor may comprise tube conduits with passes having different lengths per pass and/or different diameters per pass. Any desired combinations of any tube types arranged in parallel and/or in series are conceivable in principle.

The electrically heatable reactor may comprise a plurality of inlets and/or outlets and/or production streams. The tube conduits of different or identical tube type may be arranged in parallel and/or in series with a plurality of inlets and/or outlets. Tube conduits may be present in different tube types in the form of a modular system and selected and combined as desired depending on an intended use. The use of tube conduits of different tube types makes it possible to achieve more precise temperature management and/or adaptation of the reaction in case of varying feed and/or selective yield of the reaction and/or optimized process engineering. The tube conduits may have identical or different geometries and/or surface areas and/or materials.

The tube conduits may be continuously connected and thus form a tube system for accommodating the fluid. A “tube system” may be an apparatus composed of at least two, especially interconnected, tube conduits. The tube system may comprise supplying and discharging tube conduits. The tube system may comprise at least one inlet for admitting the fluid. The tube system may comprise at least one outlet for discharging the fluid. The term “continuously connected” is to be understood as meaning that the tube conduits are in fluid connection with one another. Thus the tube conduits may be arranged and connected such that the fluid flows through the tube conduits successively. The tube conduits may be connected to one another in parallel such that the fluid can flow through at least two tube conduits in parallel. The tube conduits, in particular the tube conduits connected in parallel, may be adapted to transport different fluids in parallel. The tube conduits connected in parallel may in particular have different geometries and/or surface areas and/or materials to one another for transport of different fluids. In particular, for the transport of a fluid a plurality or all of the tube conduits may be configured in parallel, thus allowing the fluid to be divided over said tube conduits configured in parallel. Combinations of serial and parallel connection are also conceivable.

The reaction tube may comprise for example at least one electrically conductive tube conduit for accommodating the fluid. The term “electrically conductive tube conduit” is to be understood as meaning that the tube conduit, in particular the material of the tube conduit, is adapted for conducting electric current. However, embodiments in the form of electrically nonconducting tube conduits or poorly conducting tube conduits are also conceivable.

The tube conduits and corresponding supplying and discharging tube conduits may be in fluid connection with one another. When using electrically conductive tube conduits the supplying and discharging tube conduits may be galvanically separated from one another. Galvanically separated from one another is to be understood as meaning that the tube conduits and the supplying and discharging tube conduits are separated from one another such that no electrical conduction and/or tolerable electrical conduction occurs between the tube conduits and the supplying and discharging tube conduits. The electrically heatable reactor may comprise at least one insulator, in particular a plurality of insulators. The galvanic separation between the respective tube conduits and the supplying and discharging tube conduits may be ensured by the insulators. The insulators may ensure free passage of the fluid.

The electrically heatable reactor may be electrically heated through the use of a multi-phase alternating current and/or a 1-phase alternating current and/or a direct current and/or radiation.

The electrically heatable reactor may comprise at least one alternating current source and/or at least one alternating voltage source. The alternating current source and/or alternating voltage source may be 1-phase or multi-phase. The term “alternating current source” is to be understood as meaning a current source adapted for providing an alternating current. An “alternating current” is to be understood as meaning an electric current whose polarity changes in a regular repeating pattern. The alternating current may be a sinusoidal alternating current for example. A “single-phase” alternating current source is to be understood as meaning an alternating current source providing an electric current with a single phase. A “multi-phase” alternating current source is to be understood as meaning an alternating current source providing an electric current with more than one phase. An “alternating voltage source” is to be understood as meaning a voltage source adapted for providing an alternating voltage. An “alternating voltage” is to be understood as meaning a voltage whose magnitude and polarity follows a regular repeating pattern. The alternating voltage may be a sinusoidal alternating voltage for example. The voltage produced by the alternating voltage source brings about a current flow, in particular a flow of an alternating current. A “single-phase” alternating voltage source is to be understood as meaning an alternating voltage source providing the electric current with a single phase. A “multi-phase” alternating voltage source is to be understood as meaning an alternating voltage source providing the electric current with more than one phase.

The electrically heatable reactor may comprise a plurality of single-phase or multi-phase alternating current or alternating voltage sources. Each of the tube conduits may have a respective alternating current/alternating voltage source assigned to it which is connected to the respective tube conduit, especially electrically via at least one electrical connection. Also conceivable are embodiments in which at least two tube conduits share an alternating current and/or alternating voltage source. To connect the alternating current or alternating voltage source and the respective tube conduits the electrically heatable reactor may comprise 2 to N feed conductors and 2 to N return conductors, wherein N is a natural number of not less than three. The respective alternating current and/or alternating voltage source may be adapted for producing an electric current in the respective tube conduit. The alternating current and/or alternating voltage sources may be either controlled or uncontrolled. The alternating current and/or alternating voltage sources may be configured with or without an option to control at least one electrical starting value.

“A starting value” is to be understood as meaning a current and/or a voltage value and/or a current and/or a voltage signal. The electrically heatable reactor may comprise 2 to M different alternating current and/or alternating voltage sources, wherein M is a natural number of not less than three. The alternating current and/or alternating voltage sources may be electrically controllable independently of one another. It is thus possible for example to achieve a different current in the respective tube conduits and different temperatures in the tube conduits.

The electrically heatable reactor may for example be configured as described in WO 2015/197181 A1, the contents of which are hereby incorporated by reference, and comprise at least one electrically conductive tube conduit for accommodating the fluid and at least one voltage source connected to the at least one tube conduit. The at least one voltage source is configured for producing an alternating current in the at least one tube conduit which heats the at least one tube conduit to heat the fluid.

The electrically heatable reactor may for example be configured as described in WO 2020/035574 A1, the contents of which are hereby incorporated by reference, and comprise at least one electrically conductive tube conduit for accommodating the fluid, at least one electrically conductive coil and at least one alternating current source which is connected to the coil and adapted for supplying the coil with an alternating voltage. The coil may be adapted for producing an electromagnetic field through the supplied alternating voltage. The tube conduit and the coil may be arranged such that the electromagnetic field of the coil induces an electric current in the tube conduit which heats the tube conduit through Joule heat formed upon passage of the electric current through conductive tube material to heat the fluid.

The reaction tube may for example be configured as described in EP 20 157 516.4, filed on 14 Feb. 2020, the contents of which are hereby incorporated by reference. The reaction tube may contain at least one electrically conductive tube conduit for accommodating the fluid. The electrically heatable reactor may contain at least one single-phase alternating current source and/or at least one single-phase alternating voltage source. Each tube conduit may may have a respective single-phase alternating current source and/or a single-phase alternating voltage source assigned to it which is connected to the respective tube conduit. The respective single-phase alternating current source and/or single-phase alternating voltage source may be configured for producing an electric current in the respective tube conduit which heats the respective tube conduit through through Joule heat formed upon passage of the electric current through conductive tube material to heat the fluid. The single-phase alternating current source and/or the single-phase alternating voltage source may be electrically connected to the tube conduit such that the alternating current produced flows into the tube conduit via a feed conductor and flows back to the alternating current and/or alternating voltage source via a return conductor. The fluid can flow through the tube conduit and be heated therein when the tube conduit is heated by an alternating current introduced into this tube conduit by the alternating current/or alternating voltage sources, thus producing Joule heat in the tube conduits which is transferred to the fluid, thus heating said fluid as it flows through the tube conduit. A “feed conductor” is to be understood as meaning any desired electrical conductor, in particular a supply conductor, wherein the term “feed” indicates a flow direction from the alternating current source or alternating voltage source to the tube conduit. A “return conductor” is in principle to be understood as meaning any desired electrical conductor which is adapted for conducting the alternating current away after passage through the tube conduit, in particular to the alternating current source or alternating voltage source. The term “return” indicates the flow direction from the tube conduit to the alternating current source or alternating voltage source.

The electrically heatable reactor may comprise at least one direct current and/or at least one direct voltage source. A “direct current source” is to be understood as meaning an apparatus adapted for providing a direct current. A “direct voltage source” is to be understood as meaning an apparatus adapted for providing a direct voltage. The direct current source and/or the direct voltage source are configured for producing a direct current in the respective tube conduit. The term “direct current” is to be understood as meaning an electric current which is substantially constant in strength and direction. The term “direct voltage” is to be understood as meaning a substantially constant electrical voltage. A current or voltage may be understood as being “substantially constant” when the variation thereof is immaterial for the intended effect.

The electrically heatable reactor may comprise a plurality of direct current and/or direct voltage sources. Each tube conduit may have a respective direct current and/or direct voltage source assigned to it which is connected to the respective tube conduit, in particular electrically via at least one electrical connection. To connect the direct current and/or direct voltage sources and the respective tube conduit the electrically heatable reactor 122 may comprise 2 to N positive terminals and/or conductors and 2 to N negative terminals and/or conductors, wherein N is a natural number not less than three. The respective direct current and/or direct voltage sources may be adapted for producing an electric current in the respective tube conduit. The current produced can heat the respective tube conduit through Joule heat formed upon passage of the electric current through conductive tube material to heat the fluid.

The reaction tube may for example be configured as described in WO 2020/035575 A1, the contents of which are hereby incorporated by reference, and comprises at least one electrically conductive tube conduit and/or at least one electrically conductive tube conduit segment for accommodating the fluid and at least one direct current and/or direct voltage source. The respective direct current and/or direct voltage source may be configured for producing an electric current in the respective tube conduit and/or in the respective tube conduit segment which can heat the respective tube conduit and/or the respective tube conduit segment through Joule heat formed upon passage of the electric current through conductive tube material to heat the fluid.

The electrically heatable reactor may be electrically heatable for example through the use of radiation, in particular through the use of induction, infrared radiation and/or microwave radiation.

The electrically heatable reactor may be heatable for example through the use of at least one current-conducting medium. The current or voltage source, alternating current, alternating voltage or direct current, direct voltage, may be adapted for producing an electric current in the current-conducting medium which heats the electrically heatable reactor through Joule heat formed upon passage of the electric current through the current-conducting medium. The current-conducting medium and the electrically heatable reactor may be arranged relative to one another such that the current-conducting medium at least partially surrounds the electrically heatable reactor and/or that the electrically heatable reactor at least partially surrounds the current-conducting medium. The current-conducting medium may exhibit a solid, liquid and/or gaseous state of matter selected from the group consisting of solid, liquid and gaseous and mixtures such as for example emulsions and suspensions. The current-conducting medium may for example be a current-conducting granulate or a current-conducting fluid. The current-conducting medium may comprise at least one material selected from the group consisting of: carbon, carbides, silicides, electrically conductive oils, salt melts, inorganic salts and solid/liquid mixtures. The current-conducting medium may have a specific resistance p of 0.1 Ωmm²/m≤ρ≤1000 Ωmm²/m, preferably of 10 Ωmm²/m≤ρ≤1000 Ωmm²/m.

The electrically heatable reactor may be adapted for heating the raw material to a temperature of 200° C. to 1700° C. The reactor may in particular be adapted for further heating the preheated fluid to a predetermined or prespecified temperature value through the heating. The temperature range may be independent of an application. The fluid may be heated for example to a temperature in the range from 200° C. to 1700° C., preferably from 300° C. to 1400° C., particularly preferably from 400° C. to 875° C.

The electrically heatable reactor may for example be part of a steam cracker. “Steam cracking” is to be understood as meaning a process where through thermal cracking relatively long-chain hydrocarbons, for example naphtha, propane, butane and ethane as well as gas oil and hydro-wax, by oil, biodiesel, liquids from renewable raw materials, pyrolysis oil, waste oil, are converted into short-chain hydrocarbons in the presence of steam. Steamcracking can afford ethylene, propylene, butenes and/or butadiene and benzene as reaction product. Methane, ethane, propane and/or hydrogen may be produced as byproducts for example.

The electrically heatable reactor may be adapted for a use in a steam cracker to heat the preheated fluid to a temperature in the range from 550° C. to 1700° C.

The electrically heatable reactor may for example be part of a reformer furnace, in particular for steam reforming. “Steam reforming” is to be understood as meaning a process for producing hydrogen and carbon oxides from water and carbon-containing energy carriers, in particular hydrocarbons such as natural gas, light gasoline, methanol, biogas or biomass. The fluid may for example be heated to a temperature in the range from 200° C. to 875° C., preferably from 400° C. to 700° C. Employable raw materials, also known as starting materials, include biooil, biodiesel, renewable raw materials, pyrolysis oil, waste oil. H2 and CO may be formed as main products and methane, ethane or propane may be formed as byproducts.

The electrically heatable reactor may for example be part of an apparatus for dehydrogenation. A “dehydrogenation” is to be understood as meaning a process for producing alkenes by dehydrogenation of alkanes, for example dehydrogenation of butane to butenes (BDH) or dehydrogenation of propane to propene (PDH). The apparatus for dehydrogenation may be adapted for heating the fluid to a temperature in the range from 400° C. to 700° C. The raw material employed may be ethylbenzene. Styrene and acetylene may be formed at 1700° C. as main products.

However, at the temperatures and temperature ranges are conceivable.

The plant may comprise at least one atmosphere-side connection which is adapted for allowing atmospheric exchange, in particular of reaction space atmosphere from the reaction space of the reactor into the preheater. This especially allows discharging of a reaction space atmosphere with the flue gas stream of the preheater.

The plant may comprise at least one safety device which is adapted for allowing a return stream of the raw material from the electrically heatable reactor to the preheater. In the context of the present invention a “safety device” is to be understood as meaning an apparatus which allows evacuation of the electrically heatable reactor in the case of a failure.

The plant may comprise at least one ventilation apparatus. In the context of the present invention a “ventilation apparatus” is to be understood as meaning an apparatus adapted for cooling any desired element of the plant. The ventilation apparatus may be adapted for cooling a power supply for heating the electrically heatable reactor. The ventilation apparatus may be adapted for ensuring an operating temperature, in particular a temperature range, of the power supply. This makes it possible to avoid overheating of the power supply. The ventilation apparatus may be adapted for cooling the power supply using air, in particular ambient air. During and/or as a result of the cooling process the ambient air may be heated. The ventilation apparatus may be adapted for supplying the ambient air, in particular the ambient air heated by the power supply cooling, to the preheater.

The heated ambient air may be used directly in the preheater without any need for additional heating of the ambient air.

The plant may comprise at least one heat exchanger, also referred to as a heat transferer, which is adapted for terminating chemical reactions of reaction products and/or byproducts that are in progress. The heat exchanger is arranged in the plant downstream of the electrically heatable reactor in the direction of transport of the fluid. The heat exchanger may be adapted for cooling the hot cracked gas produced by the electrically heatable reactor, in particular to a temperature of 350° C. to 400° C. The heat exchanger may comprise for example a heat cooler, in particular a high-pressure boiler feed water cooler.

The plant may comprise at least one separation section which is adapted for separating reaction products and byproducts. In the context of the present invention a “separation section” is to be understood as meaning an apparatus adapted for separating substances present in the cracked gas from one another.

The separating may comprise a purifying. The separation section may be adapted for performing at least one separating step, for example at least one distillation, in particular a rectification. The separation section may moreover comprise an absorption and/or extraction and a compressor adapted for compressing the cracked gas. In terms of its arrangement in the process of the compressor may be arranged upstream of the separating elements. The separating section may be adapted for purifying the cracked using various process engineering separation steps. The separating steps may comprise one or more of distillation, extraction, rectification, adsorption, absorption, compression, hydrogenation and phase separation. The separating elements for performing the separation steps may be arranged in the process downstream of the cracking and compression. Such separating steps and processes are known to those skilled in the art. The separation section may be adapted such that the main products to be produced are in pure form after passing through the separation section.

The plant may further comprise at least one steam system. The steam system may comprise at least one steam separator, also known as a steam drum. The steam system may be adapted for preheating boiler feed water in the preheater and introducing it into the steam drum. The steam system may comprise at least one connection between the steam drum and the heat exchanger such that the boiler feed water from the steam drum can be introduced into the heat exchanger. The heat exchanger may be adapted for returning the boiler feed water and the saturated steam to the steam drum. The steam system may further comprise at least one connection between the steam drum and the preheater such that saturated steam from the steam drum can be passed into the preheater. The preheater may be adapted for superheating the saturated steam at least for a short time. The resulting superheated high-pressure steam may be passed out of the preheater and utilized for driving turbines, for example for electricity generation.

The plant comprises at least one heat integration apparatus. In the context of the present invention a “heat integration apparatus” is to be understood as meaning an apparatus which is adapted for using, in particular reusing or further-using, generated byproducts for heat recovery to produce reaction products. Fractions of the cracked gas which are not desired as reaction product, in particular methane and hydrogen, ethane and propane, may be recycled to the preheater. In particular, excess amounts of the methane fraction produced by the electrically heatable reactor may be recycled to the preheater. The heat integration apparatus is adapted for at least partially supplying the byproducts to the preheater. The heat integration apparatus may comprise at least one conduit which is adapted for at least partially conducting and/or transporting the byproducts from the electrically heatable reactor, in particular from the separating section, to the preheater. In the context of the present invention “at least partially” is to be understood as meaning that embodiments are conceivable in which the produced byproducts are entirely supplied to the preheater and that embodiments are conceivable in which a proportion of the produced byproducts are supplied to the preheater. The preheater is adapted for at least partially utilizing energy required for preheating the raw material from the byproducts. The preheater may be adapted for at least partially utilizing energy required for heating the raw material and the process steam from the byproducts. The recycled byproducts may be burnt in the preheater and at least partially cover an energy demand of the process in the preheater. Excess amounts of the methane fraction from the cracked gas may be utilized for firing the preheater and superheating. In the context of the present invention “at least partially produce” is to be understood as meaning that the energy is entirely produced from the byproducts and/or embodiments are conceivable in which the preheater is supplied with further gases for combustion, for example from another plant, a conventional reactor based on combustion furnaces and/or a further electrically heatable reactor. Byproducts not supplied may be discharged, for example into a further plant or a further region of the plant, for example for production of further products or as a semifinished product. Possible byproducts include ethane and/or propane.

The plant may comprise at least one raw material integration apparatus which is adapted for supplying raw material not converted by the electrically heatable reactor to the preheater. In the context of the present invention a “raw material integration apparatus” is to be understood as meaning an apparatus which is adapted for using, in particular reusing or further-using, unconverted raw material as raw material for producing reaction products. The raw material integration apparatus may comprise at least one conduit which is adapted for at least partially conducting and/or transporting the unconverted raw material from the electrically heatable reactor, in particular from the separation section, to the preheater.

The electrically heatable reactor may be completely integrated into existing plants, such as conventional steam crackers, although the electrically heatable reactor does not comprise a convection zone. Complete integration is in particular possible through utilization of excess amounts of methane fraction and the presence of the separation section. This makes it possible to use conventional technology in known dimensions outside the reactor space.

An up numbering of the electrically heatable reactor may be possible analogously to existing furnaces based on gas combustion. The plant may comprise a plurality of electrically heatable reactors. The plant may additionally comprise at least one reactor having an integrated convection zone. A reactor having an integrated convection zone is to be understood as meaning a reactor which is adapted for producing the energy required for heating the fluid from the combustion of heating gas, in particular natural gas, methane, H2. The integrated convection zone of the reactor may be defined by the radiant zone.

An upscaling of the electrically heatable reactor may be possible analogously to existing furnaces based on gas combustion. Enlarging a diameter and/or a length of the electrically heatable reactor can allow production of larger amounts of reaction products.

In a further aspect the present invention proposes a process for heat integration in a production of reaction products using a plant according to the invention. The process steps may be performed in the specified sequence, wherein one or more of the steps may also at least partially be performed simultaneously and wherein one or more steps may be repeated multiple times. Furthermore, further steps may additionally be performed irrespective of whether they are mentioned in the present description or not.

The process comprises the steps of:
providing at least one raw material to a preheater via at least one raw material supply;
preheating the raw material to a predetermined temperature with the preheater;
at least partially converting the preheated raw material into reaction products and byproducts with at least one electrically heatable reactor;
at least partially supplying the byproducts to the preheater with at least one heat integration apparatus;
producing the required energy for preheating the raw material with the preheater at least partially from the byproducts.

In terms of embodiments and definitions reference may be made to the above description of the plant.

The plant according to the invention and the process according to the invention exhibit numerous advantages of known apparatuses and processes. The plant according to the invention and the process according to the invention allow integration of electrically heatable reactors, in particular heat integration, into chemical production plants. Energy required for preheating can be covered by byproducts likewise generated during production of reaction products. Further supply of fuels for preheating and for the cracking process can be avoided through the use of an electrically heatable reactor. Electricity for operating the electrically heatable reactor can be obtained from renewable sources and/or self-generated via the proposed steam system. The plant according to the invention allows an improved energy balance and reduced emissions, for example CO2, compared to plants based on combustion furnaces.

To summarize, the following embodiments are particularly preferred in the context of the present invention:

Embodiment 1: plant for producing reaction products, wherein the plant comprises at least one preheater, wherein the plant comprises at least one raw material supply which is adapted for supplying at least one raw material to the preheater, wherein the preheater is adapted for preheating the raw material to a predetermined temperature, wherein the electrically heatable reactor is adapted for at least partially converting the preheated raw material into reaction products and byproducts, wherein the plant comprises at least one heat integration apparatus which is adapted for at least partially supplying the byproducts to the preheater, wherein the preheater is adapted for at least partially utilizing energy required for preheating the raw material from the byproducts.

Embodiment 2: Plant according to the preceding embodiment, characterized in that the plant comprises at least one raw material integration apparatus which is adapted for supplying raw material not converted by the electrically heatable reactor to the preheater.

Embodiment 3: Plant according to either of the preceding embodiments, characterized in that the plant comprises at least one ventilation apparatus, wherein the ventilation apparatus is adapted for supplying ambient air to the preheater, wherein the ventilation apparatus is further adapted for cooling a power supply for heating the electrically heatable reactor.

Embodiment 4: Plant according to any of the preceding embodiments, characterized in that the electrically heatable reactor is heatable by electric current.

Embodiment 5: Plant according to any of the preceding embodiments, characterized in that the electrically heatable reactor is electrically heatable through the use of a multi-phase alternating current and/or a 1-phase alternating current and/or a direct current and/or radiation and/or induction.

Embodiment 6: Plant according to any of the preceding embodiments, characterized in that the electrically heatable reactor is adapted for heating the raw material to a temperature in the range from 200° C. to 1700° C., preferably to a temperature in the range from 300° C. to 1400° C., particularly preferably to a temperature in the range from 400° C. 875° C.

Embodiment 7: Plant according to any of the preceding embodiments, characterized in that the plant comprises at least one heat exchanger which is adapted for terminating chemical reactions of reaction products and/or byproducts that are in progress.

Embodiment 8: Plant according to any of the preceding embodiments, characterized in that the plant comprises at least one separation section which is adapted for separating reaction products and byproducts.

Embodiment 9: Plant according to any of the preceding embodiments, characterized in that the plant comprises at least one atmosphere-side connection which is adapted for allowing atmospheric exchange from the electrically heatable reactor to the preheater.

Embodiment 10: Plant according to any of the preceding embodiments, characterized in that the plant comprises at least one safety device which is adapted for allowing a return stream of the raw material from the electrically heatable reactor to the preheater.

Embodiment 11: Plant according to any of the preceding embodiments, characterized in that the plant comprises at least one process steam supply which is adapted for supplying at least one process steam to the preheater, wherein the electrically heatable reactor is adapted for converting the raw material into a cracked gas in the presence of the process steam, wherein the preheater is adapted for at least partially utilizing energy required for preheating the raw material from the byproducts.

Embodiment 12: Plant according to any of the preceding embodiments, characterized in that the raw material comprises at least one element selected from the group consisting of: methane, ethane, propane, butane, naphtha, ethylbenzene, gas oil, condensates, bioliquids, biogases, pyrolysis oils, waste oils and liquids from renewable raw materials.

Embodiment 13: Plant according to any of the preceding embodiments, characterized in that the reaction product comprises at least one element selected from the group consisting of: acetylene, ethylene, propylene, butene, butadiene, benzene, styrene, synthesis gas.

Embodiment 14: plant according to any of the preceding embodiments, characterized in that the byproduct comprises at least one element selected from the group consisting of: hydrogen, methane, ethane, propane.

Embodiment 15: Plant according to any of the preceding embodiments, characterized in that the plant is selected from the group consisting of: a plant for performing at least one endothermic reaction, a plant for heating, a plant for preheating, a steam cracker, a steam reformer, an apparatus for alkane dehydrogenation, a reformer, an apparatus for dry reforming, an apparatus for styrene production, an apparatus for ethylbenzene dehydrogenation, an apparatus for cracking ureas, isocyanates, melamine, a cracker, a catalytic cracker, an apparatus for dehydrogenation.

Embodiment 16: Plant according to any of the preceding embodiments, characterized in that the plant comprises a plurality of electrically heatable reactors.

Embodiment 17: Plant according to any of the preceding embodiments, characterized in that the plant additionally comprises at least one reactor having an integrated convection zone.

Embodiment 18: Process for heat integration in a production of reaction products using a plant according to any of the preceding embodiments relating to a plant, wherein the process comprises the steps of:
providing at least one raw material to a preheater via at least one raw material supply;
preheating the raw material to a predetermined temperature with the preheater;
at least partially converting the preheated raw material into reaction products and byproducts with at least one electrically heatable reactor;
at least partially supplying the byproducts to the preheater with at least one heat integration apparatus;
producing the required energy for preheating the raw material with the preheater at least partially from the byproducts.

### BRIEF DESCRIPTION OF THE FIGURES

Further details and features of the invention are apparent from the following description of preferred exemplary embodiments, in particular in conjunction with the subsidiary claims. The respective features may be realized by themselves alone or as a plurality in combination with one another. The invention is not limited to the exemplary embodiments. The exemplary embodiments are represented in schematic form in the figures. Identical reference numerals in the individual figures describe identical or functionally identical or functionally corresponding elements.

In particular:

FIGS. 1 to 4 shows schematic representations of exemplary embodiments of a plant according to the invention; and

FIG. 5 shows a schematic representation of a further exemplary embodiment of the plant according to the invention in the form of a steam cracker.

### EXEMPLARY EMBODIMENTS

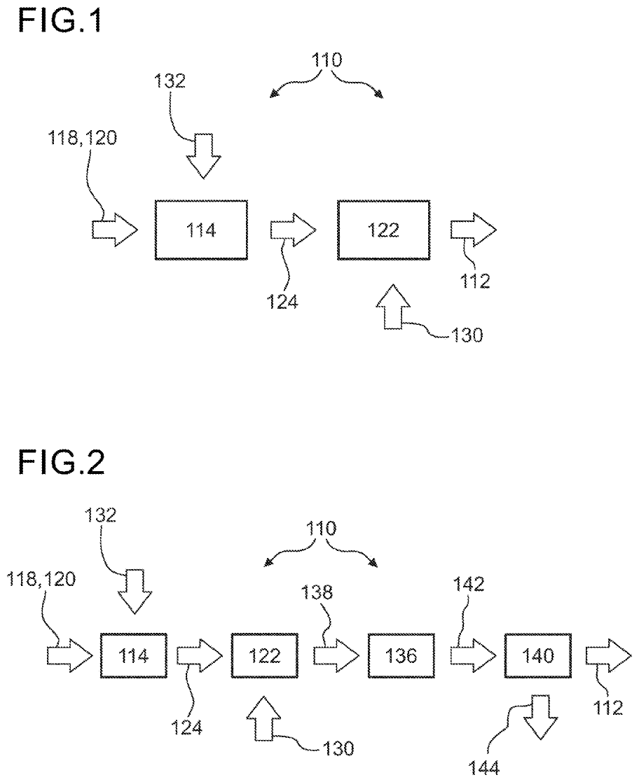

FIG. 1 shows a schematic representation of an exemplary embodiment of an inventive plant 110 for producing reaction products which are represented schematically by arrow 112 in FIG. 1. The plant 110 may be a chemical production plant. The plant 110 may for example be selected from the group consisting of: a plant for performing at least one endothermic reaction, a plant for heating, a plant for preheating, a steam cracker, a steam reformer, an apparatus for alkane dehydrogenation, a reformer, an apparatus for dry reforming, an apparatus for styrene production, an apparatus for ethylbenzene dehydrogenation, an apparatus for cracking ureas, isocyanates, melamine, a cracker, a catalytic cracker, an apparatus for dehydrogenation. The plant 110 may for example be adapted for performing at least one process selected from the group consisting of: at least one endothermic reaction, a preheating, steam cracking, steam reforming, dehydrogenation, a reforming, dry reforming, a styrene production, an ethylbenzene dehydrogenation, cracking of ureas, isocyanates, melamine, a cracking, a catalytic cracking, a dehydrogenation.

The plant 110 comprises at least one preheater 114. The preheater 114 is adapted for preheating the raw material to a predetermined temperature. The raw material may have a first temperature upon being supplied. The first temperature may be 100° C. for example. The preheater 114 may be adapted for heating the raw material to a second temperature, wherein the second temperature is higher than the first temperature. The predetermined temperature may be 500° C. to 750° C. for example. The predetermined temperature may depend on the raw material, the intended chemical reaction and/or the reaction product to be produced. The preheater 114 may comprise at least one burner 116 which is shown in FIG. 5. The preheater 114 may be adapted for producing an energy demand for preheating the raw material by combustion of gases, for example of methane. Byproducts likewise generated during production of the reaction products and recycled may be burnt in the preheater 114 and at least partially provide the energy required for heating in the preheater 114.

The raw material may in particular be a reactant with which the chemical reaction is to be performed. The raw material may be a liquid or a gaseous raw material. The raw material may comprise at least one element selected from the group consisting of: methane, ethane, propane, butane, naphthenic, ethylbenzene, gas oil, condensates, bioliquids, pyrolysis oils, waste oils and liquids from renewable raw materials. The plant 110 comprises at least one raw material supply 118 which is represented schematically as an arrow in FIG. 1. The raw material supply 118 is adapted for supplying at least one raw material to the preheater 114. The raw material supply 118 may comprise at least one tube conduit or a tube conduit system.

The plant 110 may comprise at least one process steam supply 120 which is adapted for supplying at least once process steam to the preheater 114. The process steam supply 120 is likewise represented as an arrow in FIG. 1. The process steam may in particular be steam in whose presence the raw material may be converted into reaction products and byproducts. The process steam may be a hot process steam, for example having a temperature of 180° C. to 200° C. The process steam supply 120 may be adapted for providing the process steam to the preheater 114. The process steam supply 120 may comprise at least one tube conduit or a tube conduit system.

The plant 110 comprises the at least one electrically heatable reactor 122. The electrically heatable reactor 122 is adapted for converting the preheated raw material at least partially into reaction products and byproducts. The electrically heatable reactor 122 may be adapted for converting the raw material into a cracked gas in the presence of the process steam.

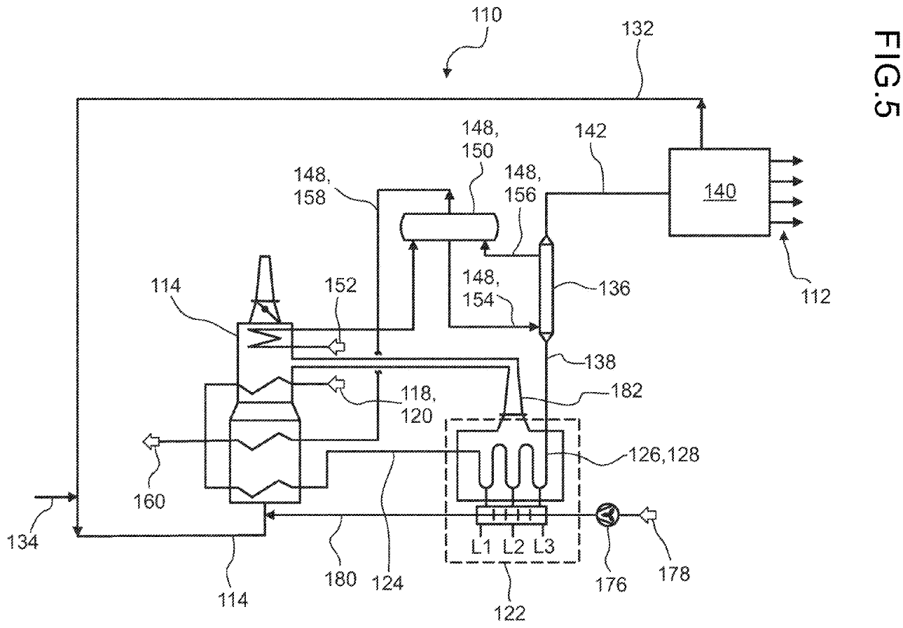

The plant 110 may comprise at least one feed conduit 124, see for example FIGS. 4 and 5, which is adapted for supplying a fluid preheated, in particular superheated, by the preheater 114 to the electrically heatable reactor 122. In particular, the raw material preheated by the preheater 114 and/or the preheated mixture of raw material and process steam may be supplied to the electrically heatable reactor 122 via the feed conduit 124. The fluid may be a gaseous and/or liquid medium.

The fluid may in particular be a mixture of raw material and process steam superheated by the preheater 114. The fluid may for example be a hydrocarbon to be thermally cracked, in particular a mixture of hydrocarbons to be thermally cracked. The fluid may for example be water or steam and additionally comprise a hydrocarbon to be thermally cracked, in particular a mixture of hydrocarbons to be thermally cracked. The fluid may for example be a preheated mixture of hydrocarbons to be thermally cracked and steam.

The plant 110 may be adapted for allowing the proceeding of a chemical reaction in which main products and byproducts are produced. The reaction product may comprise at least one element selected from the group consisting of acetylene, ethylene, propylene, butene, butadiene, benzene, styrene, synthesis gas. The byproduct may be a further product of the chemical reaction which is generated in addition to the reaction products. The byproduct may comprise at least one element selected from the group consisting of: hydrogen, methane, ethane, propane.

The electrically heatable reactor 122 may be adapted for allowing the proceeding therein of at least one chemical process and/or allowing the performing therein of at least one chemical reaction. The electrically heatable reactor 122 may be an electrically operated reactor. The electrically heatable reactor 122 may be adapted for heating a fluid present in the reactor using electric current. The electrically heatable reactor 122 may be heatable by electric current. The supply of electric current is represented with arrow 130 in FIG. 1. Electricity from any desired electricity source may in principle be used for heating the reactor 122. Electricity from renewable energy sources may advantageously be used, thus further increasing the climate compatibility of the plant 110. Furthermore, the use of a preheater 114 for producing the reaction products can result in only partial powering for processes in the electrically heatable reactor being required. This makes it possible to limit the electricity demand. An electricity and transformer concept independent of the remaining elements of the plant 110 may be possible for the electrically heatable reactor 122.

The electrically heatable reactor 122 may comprise at least one apparatus adapted for accommodating the preheated raw material. The electrically heatable reactor 122 may comprise at least one reaction tube 126, see FIG. 5, also referred to as a tube conduit, in which the chemical reaction can proceed. The reaction tube 126 may comprise for example at least one tube conduit 128 and/or at least one tube conduit segment for accommodating the fluid. The reaction tube 126 may further be adapted for transporting the fluid preheated by the preheater 114 through the electrically heatable reactor 122. The geometry and/or surface areas and/or material of the reaction tube 126 may be independent of a fluid to be transported.

The electrically heatable reactor 122 may comprise a plurality of tube conduits 128. The electrically heatable reactor 122 may comprise L tube conduits 128, wherein L is a natural number of not less than two. The electrically heatable reactor 122 may comprise for example at least two, three, four, five or more tube conduits 128. The electrically heatable reactor 122 may comprise for example up to 100 tube conduits 128. The tube conduits 128 may be identical or different.

The tube conduits 128 may comprise symmetrical and/or asymmetrical tubes and/or combinations thereof. In the case of a purely symmetrical configuration the electrically heatable reactor 122 may comprise tube conduits 128 of identical tube type. The tube type may be characterized by at least one feature selected from the group consisting of: a horizontal configuration of the tube conduit 128; a vertical configuration of the tube conduit 128, a length in the entrance (l1) and/or exit (l2) and/or transition (l3); a diameter in the entrance (d1) and exit (d2) and/or transition (d3); a number n of passes; a length per pass; a diameter per pass; a geometry, a surface area; and a material. The electrically heatable reactor 122 may comprise a combination of at least two different tube types which are connected in parallel and/or in series. The electrically heatable reactor 122 may comprise for example tube conduits 128 of different lengths in the entrance (l1) and/or exit (l2) and/or transition (l3). The electrically heatable reactor may comprise for example tube conduits having an asymmetry of diameters in the entrance (d1) and/or exit (d2) and/or transition (d3). The electrically heatable reactor may comprise for example tube conduits 128 having a different number of passes. The electrically heatable reactor 122 may comprise for example tube conduits 128 having passes with different lengths per pass an/or different diameters per pass. Any desired combinations in parallel and/or in series of any tube types are in principle conceivable.

The electrically heatable reactor 122 may comprise a plurality of inlets and/or outlets and/or production streams. The tube conduits 128 of different or identical tube type may be arranged in parallel and/or in series with a plurality of inlets and/or outlets. Tube conduits 128 may be present in different tube types in the form of a modular system and selected and combined as desired depending on an intended use. A use of tube conduits 128 of different tube types can make it possible to achieve more precise temperature management and/or adaptation of the reaction in case of varying feed and/or a selective yield of the reaction and/or optimized process engineering. The tube conduits 128 may comprise identical or different geometries and/or surface areas and/or materials.

The tube conduits 128 may be continuously connected and thus form a tube system for accommodating the fluid. The tube system may comprise supplying and discharging tube conduits. The tube system may comprise at least one inlet for admitting the fluid. The tube system may comprise at least one outlet for discharging the fluid. The tube conduits 128 may be arranged and connected such that the fluid flows through the tube conduits 128 successively. The tube conduits 128 may be connected to one another in parallel such that the fluid can flow through at least two tube conduits 128 in parallel. The tube conduits 128, in particular the tube conduits 128 connected in parallel, may be adapted to transport different fluids in parallel. The tube conduits 128 connected in parallel may in particular have different geometries and/or surface areas and/or materials to one another for transport of different fluids. In particular, for the transport of a fluid a plurality or all of the tube conduits 128 may be configured in parallel, thus allowing the fluid to be divided over said tube conduits 128 configured in parallel. Combinations of serial and parallel connection are also conceivable.

The reaction tube 126 may for example comprise at least one electrically conductive tube conduit 128 for accommodating the fluid. However, embodiments as electrically nonconducting tube conduits 128 or poorly conducting tube conduits 128 are also conceivable.

The tube conduits 128 and corresponding supplying and discharging tube conduits 128 may be in fluid connection with one another. When using electrically conductive tube conduits 28 the supplying and discharging tube conduits 128 may be galvanically separated from one another. The electrically heatable reactor 122 may comprise at least one insulator, not shown in the figures, in particular a plurality of insulators. The galvanic separation between the respective tube conduits 128 and the supplying and discharging tube conduits 128 may be ensured by the insulators. The insulators may ensure free passage of the fluid.

The electrically heatable reactor 122 may be electrically heatable through the use of a multi-phase alternating current and/or a 1-phase alternating current and/or a direct current and/or radiation.

The electrically heatable reactor 122 may comprise at least one alternating current source and/or at least one alternating voltage source. The alternating current source and/or alternating voltage source may be 1-phase or multi-phase. The alternating current may be a sinusoidal alternating current for example. The alternating voltage may be a sinusoidal alternating voltage for example. The voltage produced by the alternating voltage source brings about a current flow, in particular a flow of an alternating current. The electrically heatable reactor 122 may comprise a plurality of single-phase or multi-phase alternating current or alternating voltage sources. Each of the tube conduits 128 may have a respective alternating current and/or alternating voltage source assigned to it which is connected to the respective tube conduit 128, especially electrically via at least one electrical connection. Also conceivable are embodiments in which at least two tube conduits 128 share an alternating current and/or alternating voltage source. To connect the alternating current or alternating voltage source and the respective tube conduits 128 the electrically heatable reactor 122 may comprise 2 to N feed conductors and 2 to N return conductors, wherein N is a natural number of not less than three. The respective alternating current and/or alternating voltage source may be adapted for producing an electric current in the respective tube conduit 128. The alternating current and/or alternating voltage sources may be either controlled or uncontrolled. The alternating current and/or alternating voltage sources may be configured with or without an option to control at least one electrical starting value. The electrically heatable reactor 122 may comprise 2 to M different alternating current and/or alternating voltage sources, wherein M is a natural number of not less than three.

The alternating current and/or alternating voltage sources may be electrically controllable independently of one another. It is thus possible for example to achieve a different current in the respective tube conduits 128 and different temperatures in the tube conduits 128. The electrically heatable reactor 122 may for example be configured as described in WO 2015/197181 A1, WO 2020/035574 A1 or as in EP 20 157 516.4, filed on 14 Feb. 2020, the contents of which are hereby incorporated by reference.

The electrically heatable reactor 122 may comprise at least one direct current and/or at least one direct voltage source. The direct current source and/or the direct voltage source are configured for producing a direct current in the respective tube conduit 128. The electrically heatable reactor 122 may comprise a plurality of direct current and/or direct voltage sources. Each tube conduit 128 may have a respective direct current and/or direct voltage source assigned to it which is connected to the respective tube conduit 128, in particular electrically via at least one electrical connection. To connect the direct current and/or direct voltage sources and the respective tube conduit 128 the electrically heatable reactor 122 may comprise 2 to N positive terminals and/or conductors and 2 to N negative terminals and/or conductors, wherein N is a natural number not less than three.

The respective direct current and/or direct voltage sources may be adapted for producing an electric current in the respective tube conduit 128. The current produced can heat the respective tube conduit 128 through Joule heat formed upon passage of the electric current through conductive tube material to heat the fluid.

The electrically heatable reactor 122 may for example be configured as described in WO 2020/035575 A1, the contents of which are hereby incorporated by reference.

The electrically heatable reactor 122 may for example be electrically heatable through the use of radiation, in particular through the use of induction, infrared radiation and/or microwave radiation.

The electrically heatable reactor 122 may be heatable for example through the use of at least one current-conducting medium. The current or voltage source, alternating current, alternating voltage or direct current, direct voltage, may be adapted for producing an electric current in the current-conducting medium which heats the electrically heatable reactor 122 through Joule heat formed upon passage of the electric current through the current-conducting medium. The current-conducting medium and the electrically heatable reactor 122 may be arranged relative to one another such that the current-conducting medium at least partially surrounds the electrically heatable reactor 122 and/or that the electrically heatable reactor 122 at least partially surrounds the current-conducting medium.

The current-conducting medium may exhibit a solid, liquid and/or gaseous state of matter selected from the group consisting of solid, liquid and gaseous and mixtures such as for example emulsions and suspensions. The current-conducting medium may for example be a current-conducting granulate or a current-conducting fluid.

The current-conducting medium may comprise at least one material selected from the group consisting of: carbon, carbides, silicides, electrically conductive oils, salt melts, inorganic salts and solid/liquid mixtures. The current-conducting medium may have a specific resistance ρ of 0.1 Ωmm²/m≤ρ≤1000 Ωmm²/m, preferably of 10 Ωmm²/m≤ρ≤1000 Ωmm²/m.

The electrically heatable reactor 122 may be adapted for heating the raw material to a temperature of 200° C. to 1700° C. The reactor 122 may in particular be adapted for further heating the preheated fluid to a predetermined or prespecified temperature value through the heating. The temperature range may be independent of an application. The fluid may be heated for example to a temperature in the range from 200° C. to 1700° C., preferably from 300° C. to 1400° C., particularly preferably from 400° C. to 875° C.

The electrically heatable reactor 122 may for example be part of a steam cracker as shown in FIG. 5. “Steam cracking” is to be understood as meaning a process where through thermal cracking relatively long-chain hydrocarbons, for example naphtha, propane, butane and ethane as well as gas oil and hydro-wax, biooil, biodiesel, liquids from renewable raw materials, pyrolysis oil, waste oil, are converted into short-chain hydrocarbons in the presence of steam. Steam cracking can afford ethylene, propylene, butenes and/or butadiene and benzene as reaction product. Methane, ethane, propane and/or hydrogen may be produced as byproducts for example. The electrically heatable reactor 122 may be adapted for a use in a steam cracker to heat the preheated fluid to a temperature in the range from 550° C. to 1700° C. Raw materials, also referred to as starting materials, that may be employed include biooil, biodiesel, liquids from renewable raw materials, pyrolysis oil, waste oil. The main product formed may be butenes and the byproducts formed may be ethane or propane.

The plant 110 comprises at least one heat integration apparatus 132 which is adapted for at least partially supplying the byproducts to the preheater 114. The preheater is adapted for at least partially utilizing energy required for heating the raw material and the process steam from the byproducts. The heat integration apparatus 132 may be for using, in particular reusing or further-using, generated byproducts for heat recovery to produce reaction products. Fractions of the cracked gas which are not desired as reaction product, in particular methane and hydrogen, ethane and propane, may be recycled to the preheater 114. In particular, excess amounts of the methane fraction produced by the electrically heatable reactor 122 may be recycled to the preheater. The heat integration apparatus 132 is adapted for at least partially supplying the byproducts to the preheater 114. The heat integration apparatus 132 may comprise at least one conduit which is adapted for at least partially conducting and/or transporting the byproducts from the electrically heatable reactor to the preheater 114. The byproducts produced may be entirely supplied to the preheater 114 or a portion of the byproducts produced may be supplied to the preheater 114. The preheater 114 is adapted for at least partially utilizing energy required for preheating the raw material from the byproducts. The preheater 114 may be adapted for at least partially utilizing energy required for heating the raw material and the process steam from the byproducts. The recycled byproducts may be burnt in the preheater 144 and at least partially cover an energy demand of the process in the preheater. Excess amounts of the methane fraction from the cracked gas may be utilized for firing the preheater 114 and superheating.

The preheater may be supplied with further gases for combustion, for example from another plant, a conventional reactor based on combustion furnaces and/or a further electrically heatable reactor. The supply of further gases is indicated by arrow 134 in FIG. 5. Byproducts not supplied may be discharged, for example into a further plant or a further region of the plant 110, for example for production of further products or as a semifinished product.

FIG. 2 shows a further embodiment of the plant 110 in schematic representation. Having regard to the description of the embodiment shown in FIG. 2, reference may be made to the description of FIG. 1. In the embodiment shown in FIG. 2 the plant 110 comprises at least one heat exchanger 136 which is adapted for terminating chemical reactions of reaction products and/or byproducts that are in progress. The heat exchanger 136 is arranged in the plant 110 downstream of the electrically heatable reactor 122 in the direction of transport of the fluid. The plant 110 may comprise at least one conduit 138 which is adapted for conducting the cracked gas from the reactor 122 to the heat exchanger 136. The heat exchanger 136 may be adapted for cooling the hot cracked gas produced by the electrically heatable reactor 122, in particular to a temperature of 350° C. to 400° C. The heat exchanger 136 may comprise for example a heat cooler, in particular a high-pressure boiler feed water cooler.

The plant 110 may comprise at least one separation section 140 which is adapted for separating reaction products and byproducts. The separation section 140 may be adapted for separating substances present in the cracked gas from one another.

The cracked gas may be supplied to the separation section 140 via a further conduit 142. The separation section 140 may be adapted for performing at least one separating step, for example at least one distillation, in particular a rectification. The separation section 140 may moreover comprise an absorption and/or extraction and a compressor adapted for compressing the cracked gas.

Such separating steps and processes are known to those skilled in the art. The separation section 140 may be adapted such that the main products to be produced are in pure form after passing through the separation section 140.

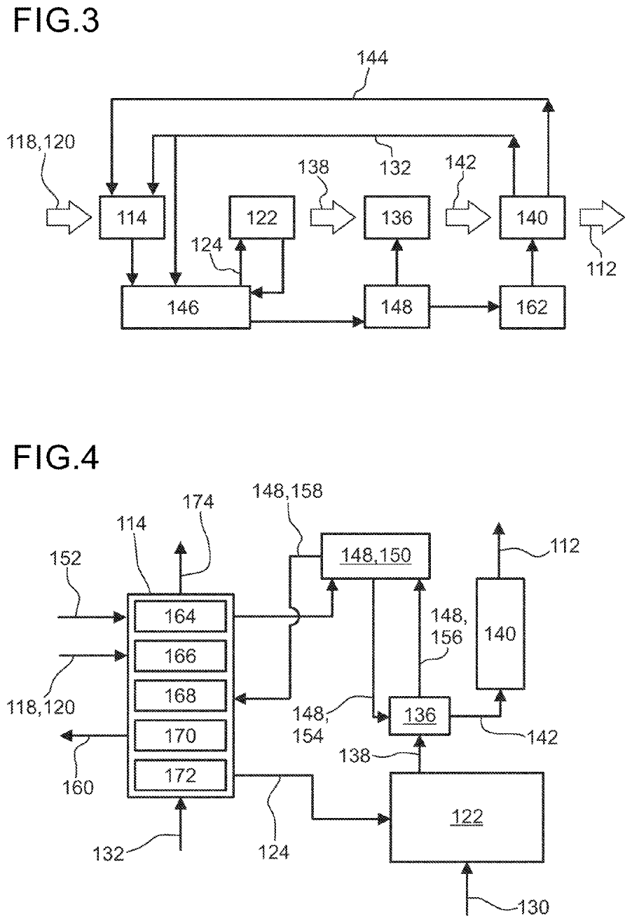

The plant 110 may comprise at least one raw material integration apparatus 144, shown schematically as arrow in FIG. 2, which is adapted for supplying raw material not converted by the electrically heatable reactor 122 to the preheater 114. The raw material integration apparatus 144 may be adapted for using, in particular reusing or further-using, unconverted raw material as raw material for producing reaction products. The raw material integration apparatus 144 may comprise at least one conduit, shown for example in FIG. 3, which is adapted for at least partially conducting and/or transporting the unconverted raw material from the electrically heatable reactor 122, in particular from the separation section 140, to the preheater 114.

FIG. 3 shows a further embodiment of the plant 110 in schematic representation. Having regard to the description of the embodiment shown in FIG. 3, reference may be made to the description of FIGS. 1 and 2. As set out above, the raw material and the process steam may in each case be supplied to and passed through the preheater 114 in tube conduits and heated by said preheater. The preheater 114 may in particular be adapted to superheat the raw material, as represented by reference 146 in FIG. 3. The plant 110 may be adapted for mixing the preheated raw material and the preheated process steam. The raw material mixed with the process steam may, for example via a further conduit, be passed into a zone of the preheater 114 close to the burner 116 and superheated. For example the raw material mixed with the process steam may be superheated to a temperature somewhat below a cracking temperature. The superheated fluid may subsequently be passed into the electrically heatable reactor 122 and cracked therein.

The plant 110 may further comprise at least one steam system 148. The steam system 148 may comprise at least one steam separator, also known as a steam drum 150, shown for example in FIGS. 4 and 5. The steam system 148 may be adapted for preheating boiler feed water 152 in the preheater 114 and introducing it into the steam drum 150. The steam system 148 may comprise at least one connection 154 between the steam drum 150 and the heat exchanger 136 such that the boiler feed water from the steam drum 150 can be introduced into the heat exchanger 136. The heat exchanger 136 may be adapted for returning the boiler feed water and the saturated steam to the steam drum 150, for example via at least one conduit 156. The steam system 148 may further comprise at least one connection 158 between the steam drum 150 and the preheater 114 such that saturated steam from the steam drum 150 can be passed into the preheater 114.

The preheater 114 may be adapted for superheating the saturated steam at least for a short time. The resulting superheated high-pressure steam may be passed out of the preheater 114 and utilized for driving turbines, for example for electricity generation, represented with arrow 160.

The plant 110 may further comprise at least one cooling circuit 162 shown in FIG. 3. A cooling circuit 162, also referred to as a refrigeration circuit, may be an open or closed circuit comprising one or more suitable refrigerants. In addition the refrigerant circuit may comprise one or more condensation and evaporation steps.

Individual different process stages may after condensation of the refrigerant be supplied with liquid refrigerant at the end pressure of the compressor. The refrigerant may be evaporated in individual process stages and, through evaporation to different pressure levels in the process stages, provides the required refrigeration power. The refrigerant evaporated in the refrigeration consumers can be recompressed to the required end pressure by a multistage compressor.

FIG. 4 shows a further embodiment of the plant 110 in schematic representation. Having regard to the description of the embodiment shown in FIG. 4, reference may be made to the description of FIGS. 1 to 3. FIG. 4 shows different zones of the preheater 114 with decreasing temperature from bottom to top. In a region 164 furthest from the burner 116 the boiler feed water 152 may be heated. Admittance of the raw material and a preheating of the raw material may be effected in a region 166 arranged therebelow. Region 168 indicates the admittance of the saturated steam introduced from the steam drum 150 which may be superheated in region 170. In a region 172 closest to the burner 116 the raw material mixed with the process steam may be superheated to a temperature somewhat below a cracking temperature. The preheater 114 may comprise a chimney through which offgas 174 from the preheater 114 may be discharged.

For a cracking of, for example, naphtha as raw material, energy utilization of the methane fraction may be as follows: the production process provides the energy of the methane fraction. This may be utilized for example to an extent of 20% or up to 20% partially for heating the boiler feed water 152 and for producing the superheated steam in the region's 168 and 170. For example 80% or up to 80% of the energy of the methane fraction may be utilized for the preheating and superheating of the raw material.

FIG. 5 shows a schematic representation of a further exemplary embodiment of the inventive plant in the form of a steam cracker. Having regard to the description of the embodiment shown in FIG. 5, reference may be made to the description of FIGS. 1 to 4. The electrically heatable reactor 122 may be completely integrated into existing plants, such as conventional steam crackers, although the electrically heatable reactor 122 does not comprise a convection zone. Complete integration is in particular possible through utilization of excess amounts of methane fraction and the presence of the separation section 140. This makes it possible to use conventional technology in known dimensions outside the reactor space.

In the embodiment shown in FIG. 5 the tube conduit 128 in the electrically heatable reactor 122 may be heated by alternating current for example. Three conductors L1, L2, L3, which are connected to the tube conduit 128, are shown.

The plant 110 may comprise at least one ventilation apparatus 176. The ventilation apparatus 176 may be adapted for cooling any desired element of the plant 110.

The ventilation apparatus 176 may be adapted for cooling a power supply for heating the electrically heatable reactor 122. The ventilation apparatus 176 may be adapted for ensuring an operating temperature, in particular a temperature range, of the power supply. This makes it possible to avoid overheating of the power supply. The ventilation apparatus 176 may be adapted for cooling the power supply using air, in particular ambient air 178. During and/or as a result of the cooling process the ambient air may be heated. The ventilation apparatus 176 may be adapted for supplying the ambient air, in particular the ambient air heated by the power supply cooling, to the preheater 114, for example using conduit 180. The heated ambient air may be used directly in the preheater 114 without any need for additional heating of the ambient air. The plant 110 may comprise at least one atmosphere-side connection which is adapted for allowing atmospheric exchange, in particular of reaction space atmosphere from the reaction space of the reactor 122 into the preheater 114. This especially allows discharging of a reaction space atmosphere with the flue gas stream of the preheater 114. The plant 110 may comprise at least one safety device 182 which is adapted for allowing a return stream of the raw material from the electrically heatable reactor 122 to the preheater 114. The safety device 182 may be adapted for allowing evacuation of the electrically heatable reactor 122 in the case of a failure.

### LIST OF REFERENCE NUMERALS

110 Plant
112 Reaction product
114 Preheater
116 Burner
118 Raw material supply
120 Process steam supply
122 Electrically heatable reactor
124 Feed conduit
126 Reaction tube
128 Tube conduit
130 Supply of electric current
132 Heat integration apparatus
134 Supply of further gases
136 Heat exchanger
138 Conduit
140 Separation section
142 Conduit
144 Raw material integration apparatus
146 Raw material superheating
148 Steam system
150 Steam drum
152 Boiler feed water
154 Connection
156 Conduit
158 Connection
160 High-pressure steam
162 Cooling circuit
164 Region
166 Region
168 Region
170 Region
172 Region
174 Offgas
176 Ventilation apparatus
178 Ambient air
180 Conduit
182 Safety device

1.-16. (canceled)

17. A plant (110) for producing reaction products, wherein the plant (110) comprises at least one preheater (114), wherein the plant (110) comprises at least one raw material supply (118) which is adapted for supplying at least one raw material to the preheater (114), wherein the preheater (114) is adapted for preheating the raw material to a predetermined temperature, wherein the plant (110) comprises at least one electrically heatable reactor (122), wherein the electrically heatable reactor (122) is an electrically operated reactor, wherein the electrically heatable reactor (122) is adapted for heating a fluid present in the reactor (122) using electric current, wherein the electrically heatable reactor (122) is adapted for at least partially converting the preheated raw material into reaction products and byproducts, wherein the plant (110) comprises at least one heat integration apparatus (132) which is adapted for at least partially supplying the byproducts to the preheater (114), wherein the preheater (114) is adapted for at least partially utilizing energy required for preheating the raw material from the byproducts, wherein the plant (110) comprises at least one safety device (182) which is adapted for allowing a return stream of the raw material from the electrically heatable tube system of the reactor (122) to the preheater (114).

18. The plant (110) according to claim 17, wherein the plant (110) comprises at least one raw material integration apparatus (144) which is adapted for supplying raw material not converted by the electrically heatable reactor (122) to the preheater (114).

19. The plant (110) according to claim 17, wherein the plant (110) comprises at least one ventilation apparatus (176), wherein the ventilation apparatus (176) is adapted for supplying ambient air to the preheater (114), wherein the ventilation apparatus (176) is further adapted for cooling a power supply for heating the electrically heatable reactor (122).

20. The plant (110) according to claim 17, wherein the electrically heatable reactor (122) is heatable by electric current.

21. The plant (110) according to claim 17, wherein the electrically heatable reactor (122) is electrically heatable through the use of a multi-phase alternating current and/or a 1-phase alternating current and/or a direct current and/or radiation and/or induction.

22. The plant (110) according to claim 17, wherein the electrically heatable reactor (122) is adapted for heating the raw material to a temperature in the range from 200° C. to 1700° C., preferably to a temperature in the range from 300° C. to 1400° C., particularly preferably to a temperature in the range from 400° C. 875° C.

23. The plant (110) according to claim 17, wherein the plant (110) comprises at least one atmosphere-side connection which is adapted for allowing atmospheric exchange from the electrically heatable reactor (122) to the preheater (114).

24. The plant (110) according to claim 17, wherein the plant (110) comprises at least one process steam supply (120) which is adapted for supplying at least one process steam to the preheater (114), wherein the electrically heatable reactor (122) is adapted for converting the raw material into a cracked gas in the presence of the process steam, wherein the preheater (114) is adapted for at least partially utilizing energy required for preheating the raw material from the byproducts.

25. The plant (110) according to claim 17, wherein the raw material supply (118) is adapted for supplying the at least one raw material to the preheater (114), wherein the raw material comprises at least one element selected from the group consisting of: methane, ethane, propane, butane, naphtha, ethylbenzene, gas oil, condensates, bioliquids, biogases, pyrolysis oils, waste oils and liquids from renewable raw materials.

26. The plant (110) according to claim 17, wherein the electrically heatable reactor (122) is adapted for at least partially converting the preheated raw material into reaction products, wherein the reaction product comprises at least one element selected from the group consisting of: acetylene, ethylene, propylene, butene, butadiene, benzene, styrene, synthesis gas.

27. The plant (110) according to claim 17, wherein the electrically heatable reactor (122) is adapted for at least partially converting the preheated raw material into byproducts, wherein the byproduct comprises at least one element selected from the group consisting of: hydrogen, methane, ethane, propane.

28. The plant (110) according to claim 17, wherein the plant (110) is selected from the group consisting of: a plant for performing at least one endothermic reaction, a plant for heating, a plant for preheating, a steam cracker, a steam reformer, an apparatus for alkane dehydrogenation, a reformer, an apparatus for dry reforming, an apparatus for styrene production, an apparatus for ethylbenzene dehydrogenation, an apparatus for cracking ureas, isocyanates, melamine, a cracker, a catalytic cracker, an apparatus for dehydrogenation.

29. The plant (110) according to claim 17, wherein the plant (110) comprises a plurality of electrically heatable reactors (122) and/or wherein the plant (110) additionally comprises at least one reactor having an integrated convection zone.

30. The plant (110) according to claim 17, wherein the plant (110) comprises at least one steam system (148).

31. The plant (110) according to claim 30, wherein the steam system (148) comprises at least one steam drum (150), wherein the steam system (148) is adapted for preheating boiler feed water in the preheater (114) and introducing it into the steam drum (150), wherein the plant (110) comprises at least one heat exchanger (136) which is adapted for terminating chemical reactions of reaction products and/or byproducts that are in progress, wherein the steam system (148) comprises at least one connection between the steam drum (150) and the heat exchanger (136) such that the boiler feed water from the steam drum (150) can be introduced into the heat exchanger (136), wherein the heat exchanger (136) is adapted for returning the boiler feed water and saturated steam to the steam drum (150), wherein the steam system (148) comprises at least one connection between the steam drum (150) and the preheater (114) such that saturated steam from the steam drum (150) can be passed into the preheater (114), wherein the preheater is adapted for superheating the saturated steam at least for a short time.

32. A process for heat integration in a production of reaction products using a plant (110) according to claim 17 relating to a plant, wherein the process comprises the steps of:
providing at least one raw material to a preheater (114) via at least one raw material supply;
preheating the raw material to a predetermined temperature with the preheater (114);
at least partially converting the preheated raw material into reaction products and byproducts with at least one electrically heatable reactor (122), wherein the electrically heatable reactor (122) is an electrically operated reactor, wherein the electrically heatable reactor (122) is adapted for heating a fluid present in the reactor (122) using electric current, wherein the plant (110) comprises at least one safety device (182) which is adapted for allowing a return stream of the raw material from the electrically heatable tube system of the reactor (122) to the preheater (114);
at least partially supplying the byproducts to the preheater (114) with at least one heat integration apparatus; and
producing the required energy for preheating the raw material with the preheater (114) at least partially from the byproducts.
